(19) United States
(12) Patent Application Publication
(10) Pub. No.: US 2014/0213255 A1
(43) Pub. Date: Jul. 31, 2014

(54) METHODS AND APPARATUSES FOR HANDLING A HANDOVER EVENT

(71) Applicant: Telefonaktiebolaget L M Ericsson (publ), Stockholm (SE)

(72) Inventors: Walter Müller, Upplands Väsby (SE); Zhiyi Xuan, Taby (SE); Stefan Wager, Espoo (FI)

(21) Appl. No.: 13/825,397

(22) PCT Filed: Jan. 28, 2013
(86) PCT No.: PCT/SE2013/050062

§ 371 Date: Mar. 21, 2013

(51) Int. Cl. H04W 36/30

(52) U.S. Cl. CPC H04W 36/30
USPC 455/436

(57) ABSTRACT

A method in a wireless device for handling a handover event from a primary cell to a neighbour cell, the primary cell being serviced by a primary network node, the neighbour cell being serviced by a neighbour network node, and the wireless device, the primary network node, the primary cell, the neighbour network node and the neighbour cell being comprised in a wireless communications network. The method comprises: determining if an entering condition for a handover event is satisfied by determining if a first entering precondition and a second entering precondition are fulfilled. The first entering precondition is based on a measurement of signal quality from the primary cell; and the second entering precondition is based on a measurement of signal strength from the neighbour cell, and a measurement of signal strength from the primary cell.

### TECHNICAL FIELD

Embodiments herein relate to a wireless device, a primary network node, a neighbour network node and methods therein. In particular, embodiments herein relate to handling a handover event.

### BACKGROUND

In cellular telecommunications, the term handover refers to the process of transferring an ongoing call or data session from one cell to another and it may imply for some deployment scenarios transferring from one network node, i.e., a primary cell served by a primary node or source network cell served by a source node, connected to a core network, to another cell or network node, i.e., a neighbour cell or target cell served by a target network node. In a typical wireless communications network, one network node may serve many cells and each cell typically only covers a limited geographical area with some overlap; therefore, handover becomes a very important feature for the seamless mobility of wireless devices in the entire wireless communications network. The performance of handover also becomes an important factor that affects the user's experience and the amount of radio resources used for the connection. One main purpose of handover is to make sure the UE connection is always maintained by being served by the best frequency and cell.

In the Long Term Evolution (LTE) Radio Access Technology (RAT), a wireless device, e.g., a user equipment (UE) in Radio Resource Control_Connected (RRC_CONNECTED) mode, measures the signal strength, e.g. the Reference Symbol Received Power (RSRP), or the signal quality, e.g., Reference Symbol Received Quality (RSRQ), of the serving cell and neighbouring cells, as schematically depicted in an example in FIG. 1. The wireless device reports the measurement results in a measurement report, either periodically or when they fulfil event criteria as defined by a network node, e.g., an eNB, such as the primary network node, according to, for example, 3rd Generation Partnership Project (3GPP) standard 36.331. One event criterion, eventA3, is fulfilled when the neighbour cell, measured on a specific frequency and a Physical Cell Identity (PCI) on that frequency, gets a certain amount stronger than the primary or serving, cell, i.e., the Offset+Hysteresis, for at least a certain minimum time, i.e., the Time to trigger. Optionally the primary network node may configure the wireless device to use Cell Individual Offset (CIO) added for a certain PCI, i.e., Offset+Hysteresis+CIO. This event is typically used as trigger for handover. That is, a handover is initiated by the primary network node after receiving a measurement report from the wireless device that indicates that at least one neighbour cell, e.g., PCI, fulfils the event criterion. There might be cases when several neighbour cells fulfil this criterion. If this happens, the wireless device sends a list, including these cells arranged in signal strength order, in the measurement report. The measurement report also contains information about measured RSRP and RSRQ for the primary cell cell and optionally RSRP and RSRQ measured values for the reported neighbouring cells, e.g., PCIs. The primary network node selects the appropriate cell as neighbour (i.e., target) cell for handover, and then translates the wireless device-reported PCI to a NW address and NW network node and cell identity for handover preparation signalling purposes.

However, it is a problem in conventional networks that handover is sometimes triggered when not really necessary, resulting in wasted network resources, or that handover may be triggered too late, resulting in a dropped connection.

### SUMMARY

It is an object of embodiments herein to improve the performance in a wireless communications network by providing an improved way to determine a condition for a handover event from a primary cell to a neighbour cell.

According to a first aspect of embodiments herein, the object is achieved by a method in a wireless device for handling a handover event from a primary cell to a neighbour cell. The primary cell is serviced by a primary network node, and the neighbour cell is serviced by a neighbour network node. The wireless device, the primary network node, the primary cell, the neighbour network node and the neighbour cell are comprised in a wireless communications network. The method comprises determining if an entering condition for a handover event is satisfied. This is performed by determining if a first entering precondition and a second entering precondition are fulfilled. The first entering precondition is based on a measurement of signal quality from the primary cell. The second entering precondition is based on a measurement of signal strength from the neighbour cell, and a measurement of signal strength from the primary cell.

According to a second aspect of embodiments herein, the object is achieved by a method in a primary network node for handling a handover event of a wireless device from a primary cell to a neighbour cell. The primary cell is serviced by a primary network node, and the neighbour cell is serviced by a neighbour network node. The wireless device, the primary network node, the primary cell, the neighbour network node and the neighbour cell are comprised in a wireless communications network. The method comprises receiving a message from the wireless device when an entering condition for a handover event is satisfied over a time period. This is determined by the wireless device when a first entering precondition and a second entering precondition are fulfilled. The first entering precondition is based on a measurement of signal quality from the primary cell. The second entering precondition is based on a measurement of signal strength from the neighbour cell, and a measurement of signal strength from the primary cell. The message comprises a measurement report.

According to a third aspect of embodiments herein, the object is achieved by a method in a neighbour network node for handling a handover event of a wireless device from a primary cell to a neighbour cell. The primary cell is serviced by a primary network node, and the neighbour cell is serviced by a neighbour network node. The wireless device, the primary network node, the primary cell, the neighbour network node and the neighbour cell are comprised in a wireless communications network. The method comprises receiving a message from the wireless device when an entering condition for a handover event is satisfied over a time period. This is determined by the wireless device when a first entering precondition and a second entering precondition are fulfilled. The first entering precondition is based on a measurement of signal quality from the primary cell. The second entering precondition is based on a measurement of signal strength from the neighbour cell, and a measurement of signal strength from the primary cell. The message comprises a measurement report.

According to a fourth aspect of embodiments herein, the object is achieved by a wireless device for handling a handover event from a primary cell to a neighbour cell. The primary cell is serviced by a primary network node, and the neighbour cell is serviced by a neighbour network node. The wireless device, the primary network node, the primary cell, the neighbour network node and the neighbour cell are comprised in a wireless communications network. The wireless device comprises a determining circuit. The determining circuit is configured to determine if an entering condition for a handover event is satisfied. This is done by determining if a first entering precondition and a second entering precondition are fulfilled. The first entering precondition is based on a measurement of signal quality from the primary cell. The second entering precondition is based on a measurement of signal strength from the neighbour cell, and a measurement of signal strength from the primary cell.

According to a fifth aspect of embodiments herein, the object is achieved by a primary network node for handling a handover event of a wireless device from a primary cell to a neighbour cell. The primary cell is serviced by a primary network node, and the neighbour cell is serviced by a neighbour network node. The wireless device, the primary network node, the primary cell, the neighbour network node and the neighbour cell are comprised in a wireless communications network. The primary network node comprises a receiving circuit. The receiving circuit is configured to receive a message from the wireless device when an entering condition for a handover event is satisfied over a time period. This is determined by the wireless device when a first entering precondition and a second entering precondition are fulfilled. The first entering precondition is based on a measurement of signal quality from the primary cell. The second entering precondition is based on a measurement of signal strength from the neighbour cell, and a measurement of signal strength from the primary cell. The message comprises a measurement report.

According to a sixth aspect of embodiments herein, the object is achieved by a neighbour network node for handling a handover event of a wireless device from a primary cell to a neighbour cell. The primary cell is serviced by a primary network node, and the neighbour cell is serviced by a neighbour network node. The wireless device, the primary network node, the primary cell, the neighbour network node and the neighbour cell are comprised in a wireless communications network. The neighbour network node comprises a receiving circuit. The receiving circuit is configured to receive a message from the wireless device when an entering condition for a handover event is satisfied over a time period. This is determined by the wireless device when a first entering precondition and a second entering precondition are fulfilled. The first entering precondition is based on a measurement of signal quality from the primary cell. The second entering precondition is based on a measurement of signal strength from the neighbour cell, and a measurement of signal strength from the primary cell. The message comprises a measurement report.

By combining the measurements of signal strength and signal quality into a single condition for handover, instead of basing the handover decision on either one of these measurements, the chances for a successful handover may be increased. That is, the probability of handover failure may be decreased.

Also, in some embodiments, by using an absolute threshold for the first entering condition and a difference threshold, i.e., the magnitude of the signals strength difference between neighbor cell and primary cell, for the second entering conditions, it is possible to enable that the handover is done to a better neighbouring cell, regardless of the absolute signal strength levels for primary cell and neighboring cell.

Thus, an advantage according to embodiments herein is that by providing a system with improved performance and, at the same time, reduce the amount of used radio resources and still allow, that subscribed satisfaction may be increased.

A further advantage according to embodiments herein is that the wireless device may be allowed to self-adjust the measurement and event evaluations on experienced local conditions without the need for a network node to send new event conditions to the wireless device, although the adaptations may still be based on network defined rules. Thus, the flexibility of the wireless communications network is enhanced without extra signalling from a network node to the wireless device.

A further advantage according to embodiments herein is that the amount of measurement reporting done over the air interface is decreased and the speed of adaptation per wireless device is larger. Thus, the overall capacity and efficiency of the wireless communications network may be increased, while the latency in the wireless communications network is decreased

A further advantage according to embodiments herein is that the chances for a successful handover may be increased without increasing the amount of handovers significantly. Thus, the overall efficiency of the wireless communications network may be increased

A yet further advantage according to embodiments herein is that they may make the handover to trigger early when the signals from the primary cell worsen rapidly, to avoid bad signal quality, and at the same time make sure that there is a relative improvement before the event is triggered. This may in turn increase handover performance in interfered and high speed wireless device scenarios, without sacrificing performance in low loaded scenarios.

As a consequence of the self-adapting properties of embodiments herein, it is yet a further advantage of embodiments herein, that tuning of NW and handover parameters may be less needed.

A yet further advantage according to embodiments herein is that the early trigger allows the nominal relative threshold, i.e., the A7 offset, to be set larger without major drawback, i.e., dropped calls, and that will decrease the amount of handover. Thus, the overall efficiency of the wireless communications network may be increased.

A yet further advantage according to embodiments herein is that they allow that a larger nominal Cell individual offset may be used to allow traffic to be served by a cell with low output power “Cell range expansion”, without getting quality degradation to a significant extent, since handover will be done when really needed.

A yet further advantage according to embodiments herein is that if a nominal offset is used, embodiments herein may improve the handover success rate by using less offset but only when motivated by poor signal quality. That is, the handover failure rate may decrease, and thus, the user's satisfaction may be increased.

A yet further advantage according to embodiments herein is that cell range expansion may be allowed when possible, but may self-adjust to not using cell range expansion when it is not possible due to downlink interference.

A yet further advantage according to embodiments herein is that more freedom is allowed in the compromise between using large handover offset to reduce the number of handovers and not getting a corresponding increase in handover failures. That is, a degradation of throughput may be avoided.

A further advantage according to embodiments herein is that the average radio resource, e.g. Physical Resource Block (PRB), consumption on the downlink signalling may be reduced. Thus, the overall capacity and efficiency of the wireless communications network are increased, while the latency in the wireless communications network is decreased.

### BRIEF DESCRIPTION OF THE DRAWINGS

Examples of embodiments herein are described in more detail with reference to attached drawings in which:

FIG. 1 is a schematic diagram illustrating a handover event according to prior art methods.

FIG. 2 is a schematic block diagram illustrating embodiments in a wireless communications system.

FIG. 3 is a flowchart depicting embodiments of a method in a wireless device.

FIG. 4 is a schematic block diagram illustrating embodiments of a handover event in a wireless communications system.

FIG. 5 is a schematic block diagram illustrating embodiments of a handover event in a wireless communications system.

FIG. 6 is a schematic diagram illustrating a handover event.

FIG. 7 is a flowchart depicting embodiments of a method in a primary network node.

FIG. 8 is a flowchart depicting embodiments of a method in a neighbour network node.

FIG. 9 is a schematic block diagram illustrating embodiments of a wireless device.

FIG. 10 is a schematic block diagram illustrating embodiments of a primary network node.

FIG. 11 is a schematic block diagram illustrating embodiments of a neighbour network node.

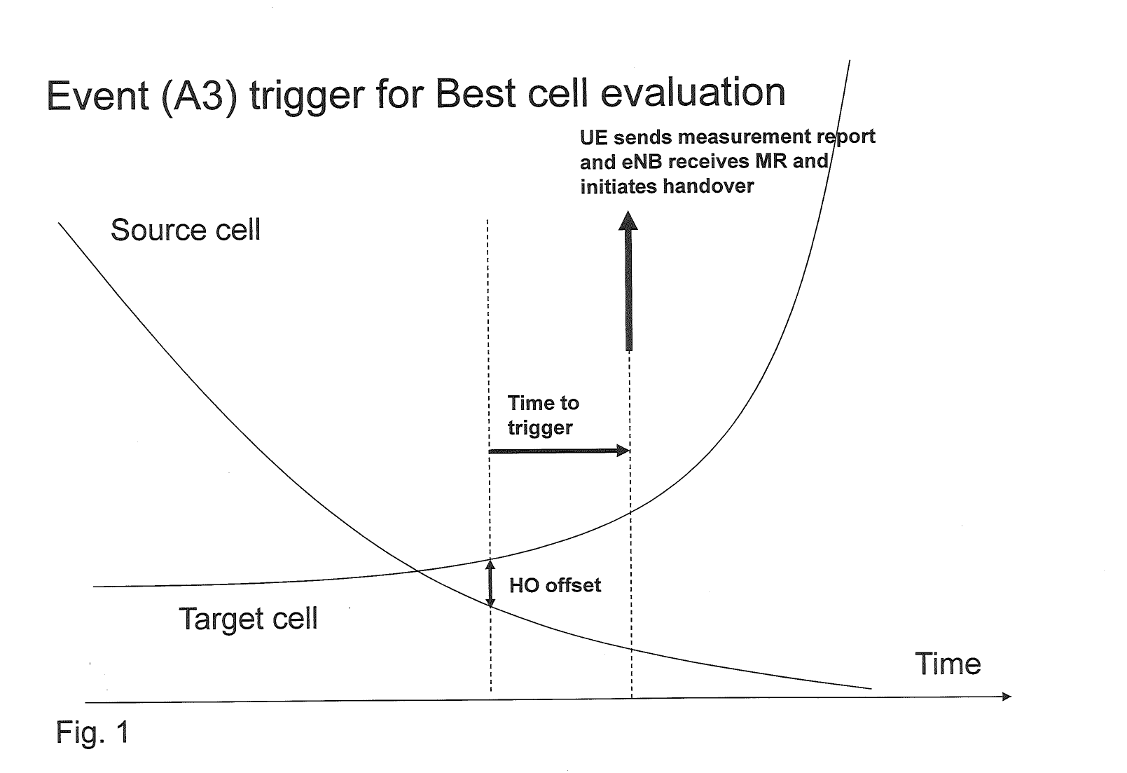

### DETAILED DESCRIPTION

As part of the development of embodiments herein, the Applicant has recognized some causes for the above-mentioned problems, which will be described below.

In a handover event, such as the A3 event, the Offset is the value of the difference between the measurement of signal strength of the primary cell and the measurement of signal strength of the neighbour cell that, when met, indicates that the signal from neighbour cell has gotten sufficiently stronger, as configured by the operator of the network, than the primary or serving cell, to trigger a handover. If the difference between the measurement of signal strength of the primary cell and the measurement of signal strength of the neighbour cell meets the Offset for a configured period of time, i.e., the time to trigger, a chain of events will start that will conclude with the execution of a handover.

The Offset and time to trigger values may be configured by the network's operator, and they may be adjusted by the operator. The adjustment of Offset and time to trigger is a compromise between doing handover too early or too late and the number of handovers.

In general, the handover may need to be done as early as possible if the quality the downlink signal is deteriorating fast, since the handover command sent to the wireless device must be able to reach the wireless device to execute the handover before the deterioration of the downlink signal has become too severe for the wireless device to receive the handover command.

Current handover events that are based on signal strength, are isolated from events based on signal quality. Because of this, the network operator may need to decide at the cell level if handover problems are due to signal strength or to signal quality.

Since both signal strength and signal quality problems may exist at the same time, but in different parts of the cell, the choice of a signal strength-based, e.g. an RSRP-based, event or a signal quality-based, e.g. an RSRQ-based, event trigger for handover is not possible without using two separate events. One event using signal strength, e.g., RSRP, as trigger quantity, and the other event using signal quality, e.g., RSRQ.

Also, in current handover events, the event's criteria are either based on an absolute threshold comparison or a relative comparison. That is, an absolute criterion is when a cell measurement, such as signal quality, is compared with an absolute threshold. A relative criterion is when a first cell measurement, such as signal strength, is compared with another cell measurement, and the difference is evaluated against a threshold.

There is no event defined in current handover events, today, that evaluates an absolute criterion and also a relative criterion.

Also, in current handover events, there is no way of combining different quantities for the same event for the same RAT, e.g. both RSRQ and RSRP evaluation in the same event.

However, in 3GPP today, there may be wireless device events that are defined and tailored for Inter Radio Access Technology HandOver (IRAT HO) evaluations. IRAT evaluations typically use a first threshold evaluated on a quantity available from a source system, e.g., LTE RSRP, and a second quantity available from the target system, e.g., WCDMA Common Pilot Channel (CPICH) Ec/No, as specified in 3GPP TS 25.331 or 25.214, but currently there is no wireless device mechanism that actually uses a combination of an absolute evaluation and a relative evaluation. Also, current specifications do not allow different quantities in the same event when both primary and neighbour cells are LTE cells.

According to embodiments herein, a wireless device may be configured for evaluation of a handover event with two criteria. One is an absolute criterion, which will be referred to as a “first entering precondition”. For example, in some embodiments, the absolute criterion may be based on an RSRQ absolute threshold for evaluating the primary, i.e., serving, cell. The other criterion is a relative criterion, which will be referred to as a “second entering precondition”. For example, in some embodiments, the relative criterion may evaluate a primary-neighbour, i.e., source-target, RSRP difference.

Embodiments herein may also allow to use different quantities, e.g. RSRQ and RSRP, within the same event, although both primary cell and neighbour cell are LTE cells. This may be accomplished by using a combined event, such as for example, combined event A7 described herein, wherein combined refers to the fact that both a signal quality measurement, e.g., RSRQ, is used in the same event as a signal strength measurement, e.g., RSRP. In this way, the event triggering may adapt to the network conditions, and trigger handover only when motivated from better signal strength, regardless of absolute level, and when signal quality is bad. Hence, extra signalling associated by using two separate events may be avoided.

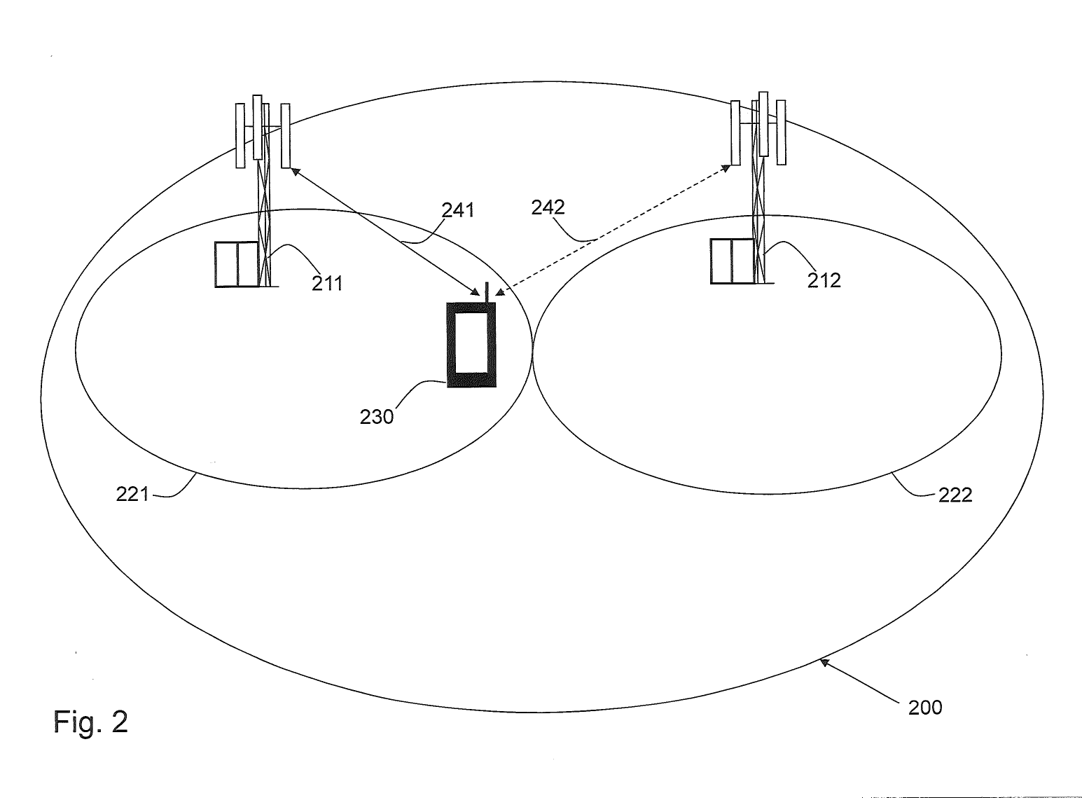

FIG. 2 depicts a wireless communications network 200, in which embodiments herein may be implemented. The wireless communications network 200 is a wireless communication network such as an LTE, a Code Division Multiple Access (CDMA) network, a Wideband Code Division Multiple Access (WCDMA) Global System for Mobile Communications (GSM) network, any 3GPP cellular network, any 3GPP2 cellular network, a Worldwide Interoperability for Microwave Access (WiMAX) network, a WiFi network, or any wireless network or system.

Wireless communications network 200 may be a heterogeneous network, or a homogeneous network.

The wireless communications network 200 comprises a primary network node 211 and a neighbour network node 212. Each of the primary network node 211 and neighbour network node 212 may be a base station such as e.g. an eNB, eNodeB, or a Home Node B, a Home eNode B, femto Base Station, BS, pico BS or any other network unit capable to serve a wireless device or a machine type communication device in a wireless communications network 200. In some particular embodiments, primary network node 211 or neighbour network node 212 may be a stationary relay node or a mobile relay node. The wireless network 200 covers a geographical area which is divided into cell areas, wherein each cell area is served by a network node, although, one network node may serve one or several cells. In the example depicted in FIG. 2, the primary network node 211 serves a primary cell 221, and the neighbour network node 212 serves a neighbour cell 222. However, in some particular embodiments not depicted in FIG. 2, the primary network node 211 may be the same as the neighbour network node 212, so that the primary cell 221 and the neighbour cell 222 may both be served by the same network node 211, 212. Each of the primary network node 211 and neighbour network node 212 may be of different classes such as e.g. macro eNodeB, home eNodeB or pico base station, based on transmission power and thereby also cell size. In some embodiments, the neighbour cell 222 may be on the same frequency as the primary cell 221. In other embodiments, the neighbour cell 222 may be on a different frequency than the primary cell 221. Typically, wireless communications network 200 may comprise more cells similar to 221 and 222, served by their respective network nodes. This is not depicted in FIG. 2 for the sake of simplicity. Each of the primary network node 211 and neighbour network node 212 may support one or several communication technologies, and its name may depend on the technology and terminology used. In 3GPP LTE, network nodes, which may be referred to as eNodeBs or even eNBs, may be directly connected to one or more core networks.

A number of wireless devices are located in the wireless communications network 200. In the example scenario of FIG. 2, only one wireless device is shown, wireless device 230. The wireless device 230 may e.g. communicate with the primary network node 211 over a radio link 241 and communicate with the neighbour network node 212 over a radio link 242.

The wireless device 230 is a wireless communication device such as a user equipment (UE), which is also known as e.g. mobile terminal, wireless terminal and/or mobile station. The device is wireless, i.e., it is enabled to communicate wirelessly in the wireless communication network 200, sometimes also referred to as a cellular radio system or cellular network. The communication may be performed e.g., between two devices, between a device and a regular telephone and/or between a device and a server. The communication may be performed e.g., via a Radio Access Network (RAN) and possibly one or more core networks, comprised within the wireless network.

The wireless device 230 may further be referred to as a mobile telephone, cellular telephone, or laptop with wireless capability, just to mention some further examples. The device 230 in the present context may be, for example, portable, pocket-storable, hand-held, computer-comprised, or vehicle-mounted mobile devices, enabled to communicate voice and/or data, via the RAN, with another entity, such as a server, a laptop, a Personal Digital Assistant (PDA), or a tablet computer, sometimes referred to as a surf plate with wireless capability, Machine-to-Machine (M2M) devices, devices equipped with a wireless interface, such as a printer or a file storage device or any other radio network unit capable of communicating over a radio link in a cellular communications system.

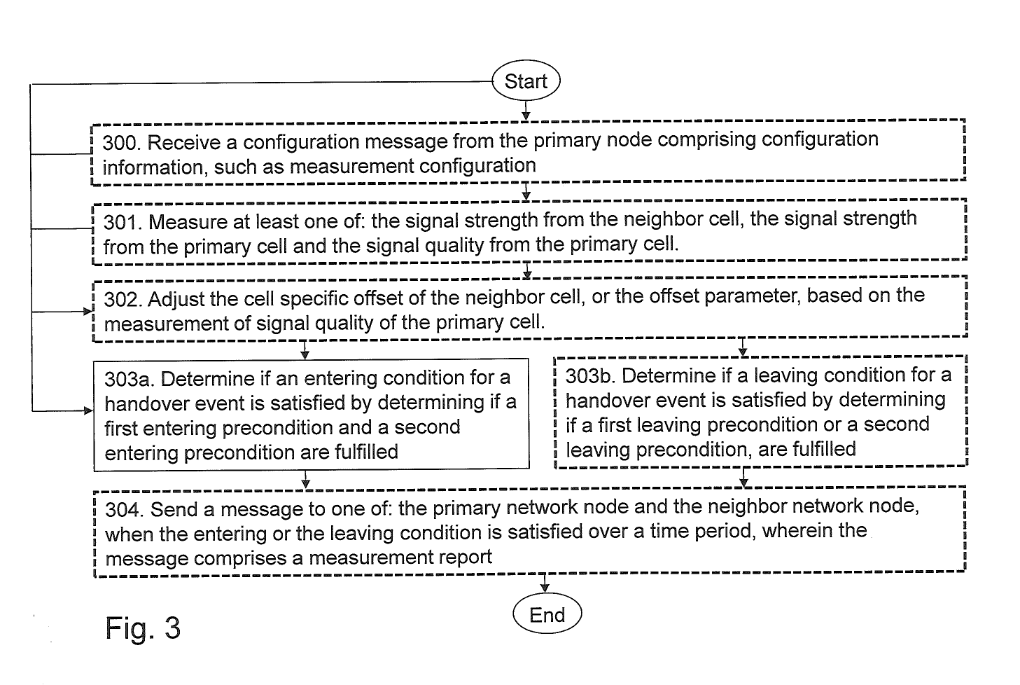

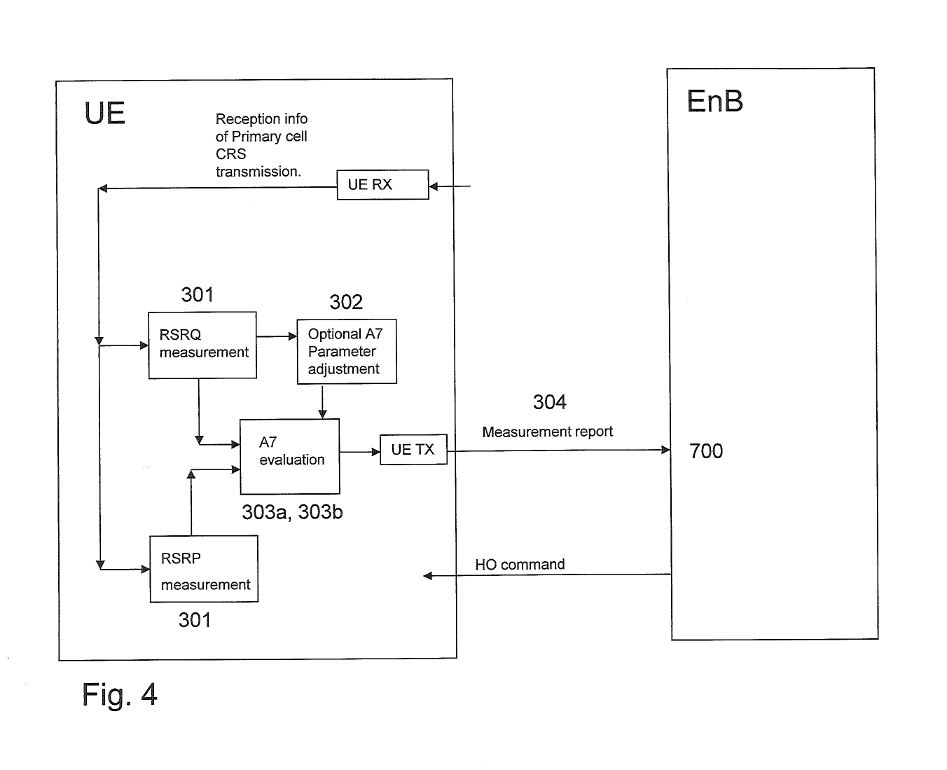

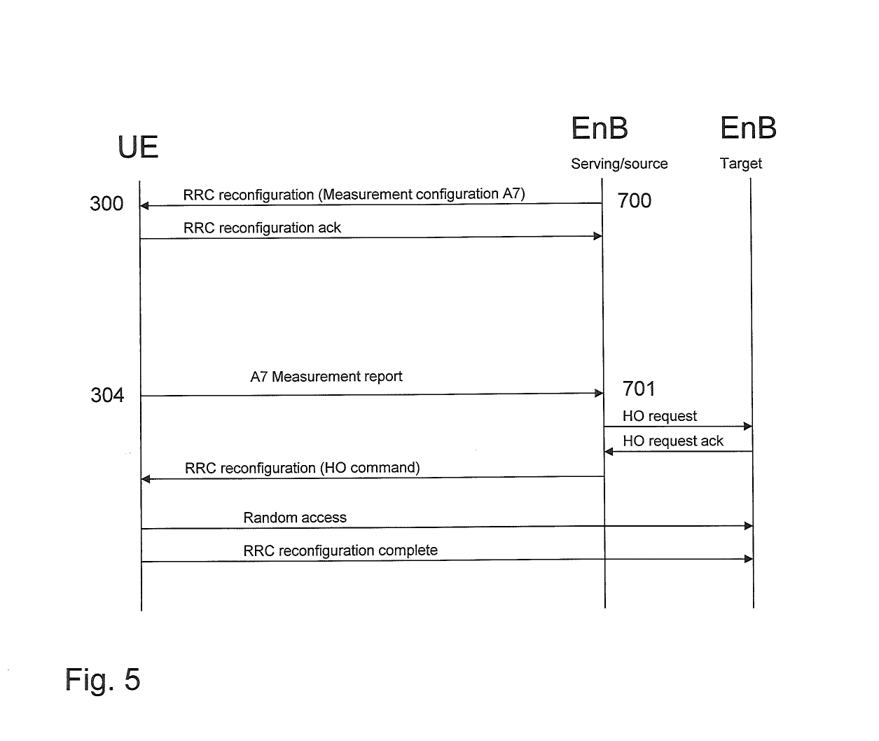

Embodiments of a method in the wireless device 230 for handling a handover event from a primary cell 221 to a neighbour cell 222 will now be described with reference to the flowchart depicted in FIG. 3, and the schematic diagrams depicted in FIG. 4 and FIG. 5. FIG. 3 depicts a flowchart of the actions that are or may be performed by the wireless device 230 in embodiments herein. Discontinued lines depict optional actions. A continuous line depicts a mandatory action. FIG. 4 depicts a summarized schematic diagram of an example of the actions that may be performed by the wireless device 230, represented here as UE, in relation to its communications with the primary network node 211, which is represented in the embodiment of this Figure as EnB. FIG. 5 is a summarized schematic diagram of an example of the communications that may occur in embodiments herein, between wireless device 230, which is represented in the embodiment of this Figure as UE, primary network node 211, which is represented in the embodiment of this Figure as EnB serving/source, and neighbour network node 212, which is represented in the embodiment of this Figure as EnB Target. As mentioned above, the primary cell 221 is serviced by the primary network node 211, the neighbour cell 222 is serviced by the neighbour network node 212, and the wireless device 230, the primary network node 211, the primary cell 221, the neighbour network node 212 and the neighbour cell 222 are comprised in the wireless communications network 200.

The method comprises the following actions, which actions may as well be carried out in another suitable order than that described below. In some embodiments, all the actions may be carried out, whereas in other embodiments only some action/s may be carried out.

Action 300

As depicted in FIG. 5, when wireless device 230 starts a connection with the primary network node 211, it may receive a configuration message from the primary network node 211, comprising configuration information. This is an optional action.

In some embodiments, the configuration information may comprise measurement configuration. The measurement configuration may configure the wireless device 230 to measure at least one of: the signal strength from the neighbour cell 222, the signal strength from the primary cell 221 and the signal quality from the primary cell 221. These measurements may allow wireless device 230 to evaluate if a handover event is necessary, by monitoring the quality of the signals received from the primary cell 221, and the strength of the signals received from the primary cell 221 and the neighbour cell 222, as described in the following actions.

The configuration information may also comprise handover parameters, as preconfigured by the network operator. The handover parameters that may be configured in the embodiments herein will be described in detail in Actions 303a, 303b and 304, e.g., Mn, Ofn, Ocn, Mp, Mpq, Ofp, Ocp, Hys, Off, Thresh, time period and second time period.

In some particular embodiments, the configuration message may be a Radio Resource Control (RRC) message.

In some further particular embodiments, the configuration message may be referred to as a Measurement configuration A7 message, as depicted in FIG. 5.

In some embodiments, the configuration message may be sent by the neighbour node 212. The configuration message sent by the neighbour network node 212 may be the same or a different message than that sent by the primary network node 211.

In some further particular embodiments, the wireless device 230 may send a message back to the primary network node 211 acknowledging the reception of the configuration message, as shown in FIG. 5.

Action 301

The wireless device 230 may evaluate if a handover event is necessary according to the configuration message received above, by monitoring the reception information received from the primary cell 221 and the neighbour cell 222. In some particular embodiments, the reception information received from the primary cell 221 may be Cell-specific Reference Signals (CRS) as described in the 3GPP TS 36.211 V10.6.0 (2012-12) specification, as depicted in FIG. 4.

Thus, in this action, the wireless device 230 may measure at least one of: the signal strength from the neighbour cell 222, the signal strength from the primary cell 221 and the signal quality from the primary cell 221. In some embodiments, the wireless device 230 may measure by recording raw data of at least one of: the signal strength from the neighbour cell 222, the signal strength from the primary cell 221 and the signal quality from the primary cell 221. In other embodiments, measuring may comprise estimating at least one of: the signal strength from the neighbour cell 222, the signal strength from the primary cell 221 and the signal quality from the primary cell 221. In these embodiments, estimating comprises collecting additional available and relevant information to enhance the accuracy of the recorded data. For example, additional available and relevant information may be information about the speed of the wireless device 230, Block Error, soft info from receiver, retransmission success rate, power used, geographical position, node configuration, and statistical analysis of data collected.

This is an optional action.

In some embodiments in this or any other action described herein, the signal strength from the neighbour cell 222 and the signal strength from the primary cell 221 may be a Reference Signal Received Power RSRP.

In some embodiments in this or any other action described herein, the signal quality from the primary cell 221 may be a Reference Signal Received Quality RSRQ or a Signal to Interference Noise Ratio SINR. In some embodiments, the signal quality from the primary cell 221, e.g., the RSRQ, may not be layer3 filtered. In other embodiments, the signal quality from the primary cell 221 may be a Channel Quality Indicator (CQI), Physical Downlink Control CHannel Block Error Rate (PDCCH BLER), soft information from data decoding, or similar signal quality indicators that will be known by one of skill in the art, and well as a combination of any of these quality signals.

Action 302

In some embodiments, the configuration information comprised in the configuration message received by the wireless device 230 in action 301, may comprise a specific offset of the neighbour cell 222. In some particular embodiments, this specific offset of the neighbour cell 222 will correspond to the Ocn value, as described in 3GPP TS 36.331, Evolved Universal Terrestrial Radio Access (E-UTRA); Radio Resource Control (RRC); Protocol specification. In other particular embodiments, the configuration information comprised in the configuration message received by the wireless device 230 in action 301, may comprise an offset parameter. In some particular embodiments, this specific offset parameter will correspond to the Off value, similar to that described in 3GPP TS 36.331, Evolved Universal Terrestrial Radio Access (E-UTRA); Radio Resource Control (RRC); Protocol specification.

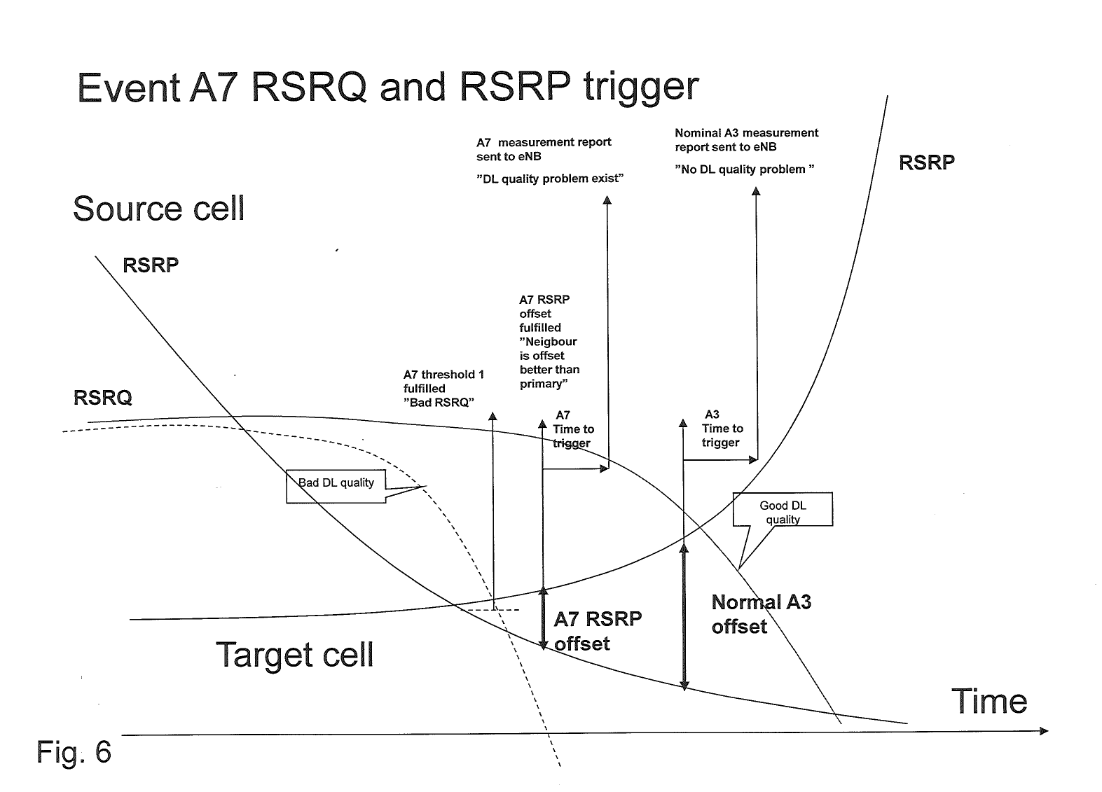

In some embodiments in which the measured signal quality of the primary cell 221 is considered to be poor, according to a first configured value, e.g., a value comprised in the configuration message received by the wireless device 230 in action 301, the wireless device 230 may adjust at least one of: the cell specific offset of the neighbour cell 222, and the offset parameter. In some specific embodiments, this adjustment may be a reduction of at least one of: the cell specific offset of the neighbour cell 222, and the offset parameter. This may be done to trigger an earlier handover event in the situations in which the signal quality of the primary network node 211 is poor. This is depicted schematically in an embodiment in the diagram of FIG. 6, in which the offset parameter, which is adjusted. In this embodiment, the measurement of signal strength from the neighbour cell 222 and the measurement of signal strength from the primary cell 221 is an RSRP measurement, and the measurement of signal quality from the primary cell 221 is an RSRQ measurement. Primary cell 221 is represented as source cell, and neighbour cell 222 is depicted as target cell.

In the embodiments in which the adjustment of the offset parameter is implemented, wherein the adjustment comprises a reduction of the offset parameter, the wireless device 230 may trigger earlier to any better cell, such as the neighbor cell 222.

In the embodiments in which the adjustment of the cell specific offset of the neighbour cell 222 is implemented, wherein the adjustment comprises a reduction of the cell specific offset of the neighbour cell 222, the wireless device 230 may trigger earlier to a particular cell, in this case, the neighbor cell 222.

In some embodiments in which the cell specific offset of the neighbour cell 222 is adjusted, the wireless device 230 may need to obtain one or more Physical Cell Identifier (PCI) from the primary network node 211, to which the reduction m be applied to.

In some embodiments in which the measured signal quality of the primary cell 221 is considered to be good, according to a second configured value, e.g., a value comprised in the configuration message received by the wireless device 230 from the primary network node 211, the wireless device 230 may also adjust the cell specific offset of the neighbour cell 222. In some specific embodiments, this adjustment may be an increase of the cell specific offset of the neighbour cell 222. This may be done, for example, to restore the specific offset of the neighbour cell 222, after it may have been reduced due to poor measured signal quality of the primary cell 221.

Thus, in this action, the wireless device 230 may optionally, in some embodiments, adjust the cell specific offset of the neighbour cell 222 based on the measurement of signal quality of the primary cell 221. For example, in some embodiments, based on the RSRQ level, a reduction of the offset is may be done by the wireless device 230, such that, for example, e.g., if RSRQ=−12 or above, then 0 dB reduction is used, and if RSRQ=−13 then 0.5 dB reduction is used, and so on. The adjustment (e.g., reduction in some embodiments), may be specified in either a table or a formula. For example, reduction=Y*(ABS(RSRQ)−X). Then, e.g. if RSRQ>−X, then the reduction is set to 0, e.g., if Y=0.5 dB, X=12 dB, then the reduction=0 at RSRQ>=−12, 0.5 dB at RSRQ=−13, 3.5 dB at RSRQ=−19 dB, 4.0 dB at RSRQ=−19.5 dB B, and so on.

Action 303a

In this action, the wireless device 230 evaluates if an entering condition for a handover event is satisfied, by taking into consideration a measurement of signal quality from the primary cell 221 and a measurement of signal strength from the neighbour cell 222 and the primary cell 221, at the same time. This is done to increase the chances for a successful handover, by combining the information of signal strength and signal quality, instead of basing the handover decision on either one of these measurements.

Thus, in this action, the wireless device 230 determines if an entering condition for a handover event is satisfied by determining if a first entering precondition and a second entering precondition are fulfilled. The first entering precondition is based on a measurement of signal quality from the primary cell 221. And the second entering precondition is based on a measurement of signal strength from the neighbour cell 222, and a measurement of signal strength from the primary cell 221. The manner in which this may be implemented is similar to that described in, for example, the 3GPP specification: TS 36.214 Evolved Universal Terrestrial Radio Access (E-UTRA); Physical layer; Measurements.

In some embodiments, the second entering precondition is further based on at least one of: a frequency specific offset of a frequency of the primary cell 221, a frequency specific offset of a frequency of the neighbour cell 222, a cell specific offset of the neighbour cell 222, a hysteresis parameter, a cell specific offset of the primary cell 221 and an offset parameter.

In some embodiments, the first entering precondition is further based on at least one of: a threshold parameter and the hysteresis parameter.

In some particular embodiments, the first entering precondition may be:

Mpq+Hys<Thresh,

and the second entering precondition may be:

Mn+Ofn+Ocn−Hys>Mp+Ofp+Ocp+Off,

wherein:
Mn is the measurement of signal strength from the neighbour cell 222,
Ofn is the frequency specific offset of the frequency of the neighbour cell 222,
Ocn is the cell specific offset of the neighbour cell 222, wherein Ocn is set to zero when configured for a cell that is not the neighbour cell 222,
Mp is the measurement of signal strength from the primary cell 221,
Mpq is the measurement of signal quality of the primary cell 221,
Ofp is the frequency specific offset of the primary frequency of the primary cell 221,
Ocp is the cell specific offset of the primary cell 221, and is set to zero when configured for a cell that is not the primary cell 221,
Hys is the hysteresis parameter for this event,
Off is the offset parameter, wherein the offset is an A7 offset parameter for this event, i.e., an offset similar to the A3 offset, but for this A7 event,
Thresh is the threshold parameter for this event.

In some particular embodiments, the offset parameter may have a lower value than the A3 offset.

In some particular embodiments, action 303a may be referred to as an evaluation of an A7 handover event, in reference to the handover events existing in current specifications, such as that described in the Evolved Universal Terrestrial Radio Access (E-UTRA); Radio Resource Control (RRC); Protocol specification 36.331. This will be described in detail below, in reference to both, actions 303a and action 303b.

One of the advantages according to embodiments herein, may be that more freedom is allowed in the compromise between using large handover offset to reduce the number of handovers and not getting a corresponding increase in handover failures. That is, a degradation of throughput may be avoided, such as in the instances in which, for example, the handover is triggered late. In these instances, the neighbour cell 222 may be considerably better than the primary cell 221, so that the neighbour cell 222 access may have a high probability to succeed. However, the signalling to the wireless device 230 from the primary cell 221, e.g., the “handover command”, may not be received by the wireless device 230, as the connection to the primary cell 221 may be by then too poor.

Action 303b

In some particular embodiments, the wireless device 230 may determine if a leaving condition for the handover event is satisfied by determining if a first leaving precondition or a second leaving precondition, are fulfilled. The first leaving precondition may be based on the measurement of signal quality from the primary cell 221. And the second leaving precondition may be based on the measurement of signal strength from the neighbour cell 222 and the measurement of signal strength from the primary cell 221.

In some embodiments, the second leaving precondition may be further based on at least one of: a frequency specific offset of a frequency of the primary cell 221, a frequency specific offset of a frequency of the neighbour cell 222, a cell specific offset of the neighbour cell 222, a hysteresis parameter, a cell specific offset of the primary cell 221 and an offset parameter.

In some embodiments, the first leaving precondition may be further based on at least one of: a threshold parameter and the hysteresis parameter.

In some particular embodiments, the first leaving precondition may be:

Mpq−Hys>Thresh,

and the second leaving precondition may be:

Mn+Ofn+Ocn+Hys<Mp+Ofp+Ocp+Off,

wherein each of these variables corresponds to those described for action 303a.

This action is optional.

In the embodiments in which the leaving condition for the handover event is satisfied, as determined in this action, over a time period, e.g., a time to trigger or TTT, or a second time period, different from that described above, the wireless device 230 may reset a time period timer which keeps track of the time period and/or the second time period.

In some particular embodiments, actions 303a and 303b may be referred to as an evaluation of an A7 handover event, in reference to the handover events existing in current specifications, such as that described in the Evolved Universal Terrestrial Radio Access (E-UTRA); Radio Resource Control (RRC); Protocol specification 36.331. In these embodiments, and based on this specification language, in Event A7, the primary cell 721, e.g., PCell, becomes worse than a threshold, and the neighbour cell 722 becomes offset better than the primary cell 721. In these embodiments, the wireless device 230, e.g., a UE, may:
1> consider the entering condition for this event to be satisfied when both condition A7-1 and condition A7-2, as specified below, are fulfilled;
1> consider the leaving condition for this event to be satisfied when condition A7-3 or condition A7-4, i.e. at least one of the two, as specified below, is fulfilled.

In some of these particular embodiments, the cell(s) that triggers the event is on the frequency indicated in the associated measObject, which may be different from the primary frequency used by the primary cell 721. In some of these particular embodiments the A7-1 to A7-4 conditions may be:

### Inequality A7-1 (Entering Condition 1)

Mpg+Hys<Thresh

### Inequality A7-2 (Entering Condition 2)

Mn+Ofn+Ocn−Hys>Mp+Ofp+Ocp+Off

### Inequality A7-3 (Leaving Condition 1)

Mpq−Hys>Thresh

### Inequality A7-4 (Leaving Condition 2)

Mn+Ofn+Ocn+Hys<Mp+Ofp+Ocp+Off

In these particular embodiments, the variables in the formulas A7-1 to A7-4 may be defined as follows:
Mn is the measurement result of the neighbour cell 722, i.e., the neighbouring cell, not taking into account any offsets.
Ofn is the frequency specific offset of the frequency of the neighbour cell 722, i.e., the neighbour cell (i.e. offsetFreq as defined within measObjectEUTRA corresponding to the frequency of the neighbour cell 722, i.e., the neighbour cell).
Ocn is the cell specific offset of the neighbour cell 722, i.e., the neighbour cell (i.e. cellIndividualOffset as defined within measObjectEUTRA corresponding to the frequency of the neighbour cell 722, i.e., the neighbour cell), and set to zero if not configured for the neighbour cell 722, i.e., the neighbour cell.
Mp is the measurement result of the primary cell 721, i.e., the PCell, not taking into account any offsets.
Mpq is the measurement result of the primary cell 721, i.e., PCell, not taking into account any offsets.
Ofp is the frequency specific offset of the primary frequency (i.e. offsetFreq as defined within measObjectEUTRA corresponding to the primary frequency of the primary cell 721).
Ocp is the cell specific offset of the primary cell 721, i.e., the PCell (i.e. cellIndividualOffset as defined within measObjectEUTRA corresponding to the primary frequency of the primary cell 721), and is set to zero if not configured for the primary cell 721, i.e., the PCell.
Hys is the hysteresis parameter for this event (i.e. hysteresis as defined within reportConfigEUTRA for this event).
Off is the offset parameter for this event (i.e. a7-Offset similar to the a3-Offset as defined within reportConfigEUTRA for this event).

In some of these particular embodiments,
Mn, Mp, Mpq are expressed in dBm in case of RSRP, or in dB in case of RSRQ.

In some of these particular embodiments,
Ofn, Ocn, Ofp, Ocp, Hys, Off are expressed in dB.
Thresh is the threshold parameter for this event (i.e. a7-Threshold as defined within reportConfigEUTRA for this event).

Action 304

When the entering condition as described in action 303a is satisfied over a time period, e.g., a time to trigger, in this action, the wireless device 230 may send a message to one of: the primary network node 211 and the neighbour network node 212. The message may comprise a measurement report for triggering the handover event. An example of how this may be done may be found, for example, in 3GPP TS 36.300.

In some embodiments, the measurement report may be referred to as an A7 measurement report, as depicted schematically in the embodiments of FIGS. 5 and 6.

In some embodiments, a handover evaluation as that described in embodiments herein may be used in parallel with a handover evaluation according to prior art methods. In these embodiments, a handover evaluation as that described in embodiments herein may be triggered if there is poor signal quality, and a prior art handover evaluation may be triggered if there is good signal quality. For example, in some embodiments, such as that represented in FIG. 6, A7 and A3 evaluation may be used in parallel, i.e., at the same time, and the wireless device 230 may trigger on either an A7 measurement report or an A3 measurement report. An A7 measurement report may be triggered if there is poor signal quality, and an A3 measurement report may be triggered if there is good signal quality. The primary network node 211 may then execute a handover upon receiving the A7 or A3 message. In other embodiments, however, such as in those where the wireless device 230 adjusting of A7 parameters may be used, the A3 measurement report may not be used, and only the A7 measurement report may be used.

In response to the message sent in this action, the wireless device 230 may receive a reconfiguration message, i.e., a handover command, from one, or both, of: the primary network node 211 and the neighbour network node 212. In some particular embodiments, this reconfiguration message may be an RRC reconfiguration message, as depicted in the example of FIG. 5. The wireless device 230 may then, in some embodiments, initiate access to the neighbour node 212, and send a message to the neighbour node 212 indicating that the reconfiguration, i.e., the handover in this case, is complete, according to known methods.

In the embodiments in which the leaving condition for the handover event is satisfied over the time period or the second time period, the wireless device 230 may also send a second message to one or both of: the primary network node 211 and the neighbour network node 212. The second message may comprise a measurement report for reporting the cancelling of the handover event.

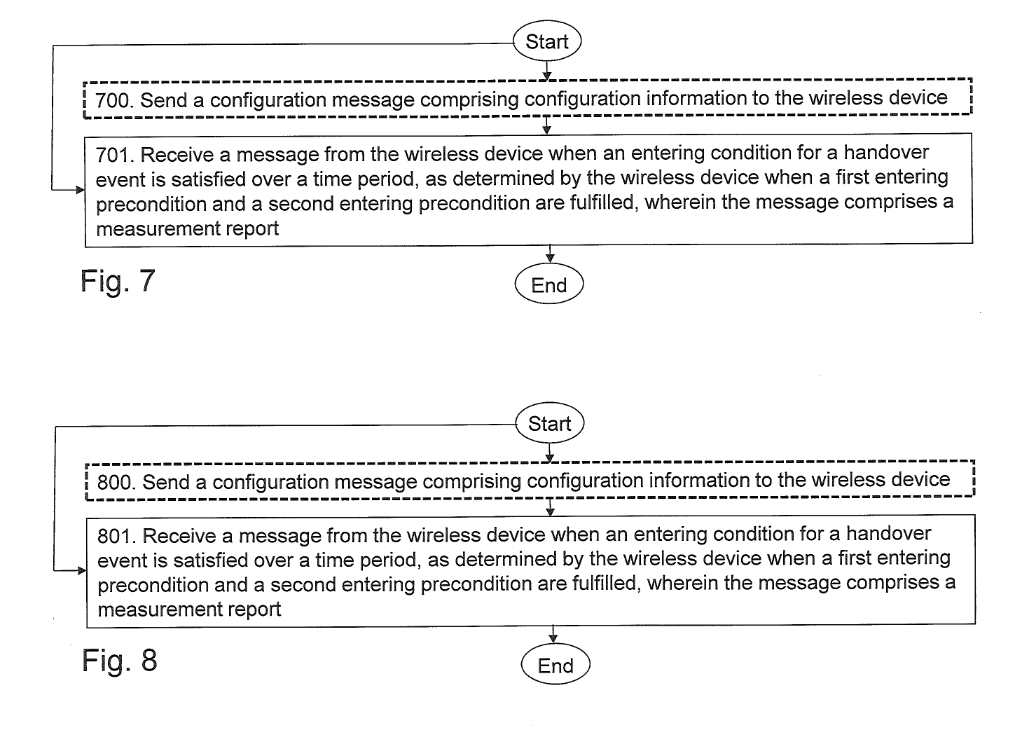

Embodiments of a method in the primary network node 211 for handling a handover event of a wireless device 230 from a primary cell 221 to a neighbour cell 222 will now be described with reference to the flowchart depicted in FIG. 7, and the schematic diagrams depicted in FIG. 4 and FIG. 5. FIG. 7 depicts a flowchart of the actions that are or may be performed by the primary network node 211 in embodiments herein. Discontinued lines depict optional actions. A continuous line depicts a mandatory action. As mentioned above, the primary cell 221 is serviced by the primary network node 211, the neighbour cell 222 is serviced by the neighbour network node 212, and the wireless device 230, the primary network node 211, the primary cell 221, the neighbour network node 212 and the neighbour cell 222 are comprised in the wireless communications network 200. As also mentioned earlier, in some embodiments, the primary network node 211 and the neighbour node 212 may be the same node, so that the primary cell 221 and the neighbour cell 222 may both be served by the same network node 211, 212.

The method comprises the following actions, which actions may as well be carried out in another suitable order than that described below. In some embodiments, all the actions may be carried out, whereas in other embodiments only some action's may be carried out.

Action 700

As depicted in FIG. 5, the primary network node 211 may send a configuration message comprising configuration information to the wireless device 230, when the wireless device 230 starts a connection with the primary network node 211. This is an optional action.

In some embodiments, the configuration information may comprise measurement configuration. The measurement configuration may configure the wireless device 230 to measure at least one of: the signal strength from the neighbour cell 222, the signal strength from the primary cell 221 and the signal quality from the primary cell 221, as described above.

The configuration information may also comprise handover parameters, as preconfigured by the network operator, such Mn, Ofn, Ocn, Mp, Mpq, Ofp, Ocp, Hys, Thresh, time period and second time period, as described above.

In some particular embodiments, the configuration message may be a Radio Resource Control (RRC) message.

In some further particular embodiments, the configuration message may be referred to as a Measurement configuration A7 message, as depicted in FIG. 5.

In some further particular embodiments, the primary network node 211 may receive a message back from the wireless device 230 acknowledging the reception of the configuration message, as shown in FIG. 5.

Action 701

In this action, the primary network node 211 receives a message from the wireless device 230 when an entering condition for a handover event is satisfied over a time period, as determined by the wireless device 230 when a first entering precondition and a second entering precondition are fulfilled, wherein the first entering precondition is based on a measurement of signal quality from the primary cell 221; and wherein the second entering precondition is based on a measurement of signal strength from the neighbour cell 222, and a measurement of signal strength from the primary cell 221, and wherein the message comprises a measurement report.

The message received in this action, the entering condition, the handover event, the time period, the first entering precondition, the second entering precondition, the measurement of signal quality from the primary cell 221, the measurement of signal strength from the neighbour cell 222, the measurement of signal strength from the primary cell 221, and the message comprising the measurement report are the same as those described in relation to actions 300-304. Thus, a description for these terms will not be repeated here.

In some embodiments, this action may be referred to as a reception of an A7 measurement report, in reference to the handover events existing in current specifications, such as the 3GPP TS 36.331, Evolved Universal Terrestrial Radio Access (E-UTRA); Radio Resource Control (RRC); Protocol specification.

In response to this action 701, the primary network node 211 may send a message to the neighbour node 212 which may comprise a handover request, as depicted in FIG. 5. Once a message from the neighbour node 212 is received, comprising for example, an acknowledgement of the handover request and configuration information, as shown in FIG. 5, the primary network node 211 may then send a new message comprising a handover command to the wireless device 230, as depicted in FIG. 4. In the particular embodiments in which the primary cell 221 and neighbour cell 222 may be both served by the same primary network node 211, the handover request signalling is not needed. In some embodiments, the primary network node 211 may transmit the handover command also via the neighbour cell 222, instead of or in addition to the primary cell 221.

Embodiments of a method in the neighbour network node 212 for handling a handover event of a wireless device 230 from a primary cell 221 to a neighbour cell 222 will now be described with reference to the flowchart depicted in FIG. 8, and the schematic diagrams depicted in FIG. 4 and FIG. 5. FIG. 8 depicts a flowchart of the actions that are or may be performed by the neighbour network node 212 in embodiments herein. Discontinued lines depict optional actions. A continuous line depicts a mandatory action. As mentioned above, the primary cell 221 is serviced by the primary network node 211, the neighbour cell 222 is serviced by the neighbour network node 212, and the wireless device 230, the primary network node 211, the primary cell 221, the neighbour network node 212 and the neighbour cell 222 are comprised in the wireless communications network 200.

The method comprises the following actions, which actions may as well be carried out in another suitable order than that described below. In some embodiments, all the actions may be carried out, whereas in other embodiments only some action/s may be carried out.

Action 800

The neighbour node 212 may send a configuration message comprising configuration information to the wireless device 230, instead of or in addition to that sent by the primary network node 211. This is an optional action.

In some embodiments, the configuration information may comprise measurement configuration. The measurement configuration may configure the wireless device 230 to measure at least one of: the signal strength from the neighbour cell 222, the signal strength from the primary cell 221 and the signal quality from the primary cell 221, as described above.

The configuration information may also comprise handover parameters, as preconfigured by the network operator, such Mn, Ofn, Ocn, Mp, Mpq, Ofp, Ocp, Hys, Thresh, time period and second time period, as described above.

In some particular embodiments, the configuration message may be a Radio Resource Control (RRC) message.

In some further particular embodiments, the configuration message may be referred to as a Measurement configuration A7 message.

The configuration message sent by the neighbour network node 212 may be the same or a different message than that sent by the primary network node 211.

In some further particular embodiments, the wireless device 230 may send a message back to the neighbour network node 212 acknowledging the reception of the configuration message.

Action 801

Thus, in this action, the neighbour network node 212 receives a message from the wireless device 230 when an entering condition for a handover event is satisfied over a time period, as determined by the wireless device 230 when a first entering precondition and a second entering precondition are fulfilled, wherein the first entering precondition is based on a measurement of signal quality from the primary cell 221; and wherein the second entering precondition is based on a measurement of signal strength from the neighbour cell 222, and a measurement of signal strength from the primary cell 221, and wherein the message comprises a measurement report.

The message received in this action, the entering condition, the handover event, the time period, the first entering precondition, the second entering precondition, the measurement of signal quality from the primary cell 221, the measurement of signal strength from the neighbour cell 222, the measurement of signal strength from the primary cell 221, and the message comprising the measurement report are the same as those described in relation to actions 300-304. Thus, a description for these terms will not be repeated here.

In some embodiments, this action may be referred to as a reception of an A7 measurement report, in reference to the handover events existing in current specifications, such as 3GPP TS 36.331, Evolved Universal Terrestrial Radio Access (E-UTRA); Radio Resource Control (RRC); Protocol specification.

In response to this action 801, the neighbour network node 212 may send a message to the primary network node 211 which may comprise a handover request. Once a message from the primary network node 211 is received, comprising for example, an acknowledgement of the handover request, the neighbour node 212 may then send a new message comprising a handover command to the wireless device 230, as depicted in FIG. 4.

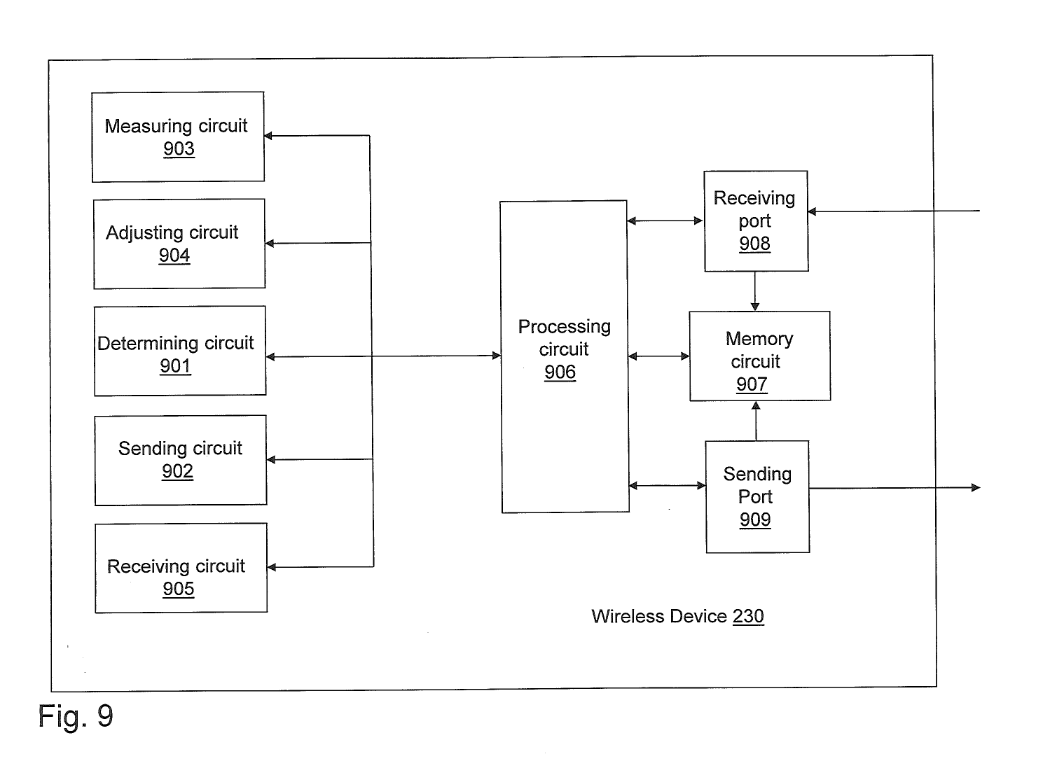

To perform the method actions in the wireless device 230 described above in relation to FIGS. 3-6 for handling a handover event from a primary cell 221 to a neighbour cell 222, the wireless device 230 comprises the following arrangement depicted in FIG. 9. As mentioned above, the primary cell 221 is serviced by a primary network node 211, the neighbour cell 222 is serviced by a neighbour network node 212, and the wireless device 230, the primary network node 211, the primary cell 221, the neighbour network node 212 and the neighbour cell 222 are comprised in a wireless communications network 200.

The wireless device 230 comprises an determining circuit 901, configured to determine if an entering condition for a handover event is satisfied by determining if a first entering precondition and a second entering precondition are fulfilled, wherein the first entering precondition is based on a measurement of signal quality from the primary cell 221; and wherein the second entering precondition is based on a measurement of signal strength from the neighbour cell 222, and a measurement of signal strength from the primary cell 221.

In some embodiments, the wireless device 230 may further comprise a sending circuit 902 configured to send a message to one of: the primary network node 211 and the neighbour network node 212, when the entering condition is satisfied over a time period, wherein the message comprises a measurement report.

In some embodiments, the determining circuit 901 may be further configured to determine if a leaving condition for a handover event is satisfied by determining if a first leaving precondition or a second leaving precondition, are fulfilled, wherein the first leaving precondition is based on the measurement of signal quality from the primary cell 221; and wherein the second leaving precondition is based on the measurement of signal strength from the neighbour cell 222 and the measurement of signal strength from the primary cell 221.

In some embodiments, the sending circuit 902 may be further configured to send a message to one of: the primary network node 211 and the neighbour network node 212, when the leaving condition is satisfied over a time period or a second time period, wherein the message comprises a measurement report.

In some embodiments, at least one of the second entering precondition and the second leaving precondition may be further based on at least one of: a frequency specific offset of a frequency of the primary cell 221, a frequency specific offset of a frequency of the neighbour cell 222, a cell specific offset of the neighbour cell 222, a hysteresis parameter, a cell specific offset of the primary cell 221 and an offset parameter; and the first entering precondition and the first leaving precondition may be further based on at least one of: a threshold parameter and the hysteresis parameter.

In some embodiments, the wireless device 230 may further comprise a measuring circuit 903 configured to measure at least one of: the signal strength from the neighbour cell 222, the signal strength from the primary cell 221 and the signal quality from the primary cell 221.

In some other embodiments, the first entering precondition may be:

Mpq+Hys<Thresh,

and the second entering precondition is:

Mn+Ofn+Ocn−Hys>Mp+Ofp+Ocp+Off
wherein:
Mn is the measurement of signal strength from the neighbour cell 222,
Ofn is the frequency specific offset of the frequency of the neighbour cell 222,
Ocn is the cell specific offset of the neighbour cell 222, wherein Ocn is set to zero when configured for a cell that is not the neighbour cell 222,
Mp is the measurement of signal strength from the primary cell 221,
Mpq is the measurement of signal quality of the primary cell 221,
Ofp is the frequency specific offset of the primary frequency of the primary cell 221,
Ocp is the cell specific offset of the primary cell 221, and is set to zero when configured for a cell that is not the primary cell 221,
Hys is the hysteresis parameter for this event,
Off is the offset parameter, wherein the offset is an A7 offset parameter for this event,
Thresh is the threshold parameter for this event.

In some particular embodiments, the handover parameters just described may be further defined as described above in relation to an A7 handover event.

In some embodiments, the first leaving precondition may be:

Mpq+Hys<Thresh, and

the second leaving precondition is:

Mn+Ofn+Ocn+Hys<Mp+Ofp+Ocp+Off

In some embodiments, the signal strength from the neighbour cell 222 and the signal strength from the primary cell 221 may be a Reference Signal Received Power RSRP.

In some embodiments, the signal quality from the primary cell 221 may be a Reference Signal Received Quality, RSRQ, or a Signal to Interference and Noise Ratio, SINR.

In some embodiments, the wireless device 230 may further comprise an adjusting circuit 904 configured to adjust the cell specific offset of the neighbour cell 222 based on the measurement of signal quality of the primary cell 221.

In some embodiments, the wireless device 230 may further comprise a receiving circuit 905 configured to receive a configuration message from at least one of: the primary network node 211 and the neighbour network node 212, comprising configuration information.

The embodiments herein for handling a handover event from a primary cell 221 to a neighbour cell 222 may be implemented through one or more processors, such as a processing circuit 906 in the wireless device 230 depicted in FIG. 9, together with computer program code for performing the functions and actions of the embodiments herein. The program code mentioned above may also be provided as a computer program product, for instance in the form of a data carrier carrying computer program code for performing the embodiments herein when being loaded into the in the wireless device 230. One such carrier may be in the form of a CD ROM disc. It may be however feasible with other data carriers such as a memory stick. The computer program code may furthermore be provided as pure program code on a server and downloaded to the wireless device 230. One or more circuits in processing circuit 906 may for example carry out the configuration actions as described in action 300 and 304, based on configuration messages received from either the primary network node 211 and/or the neighbour network node 212.

The wireless device 230 may further comprise a memory circuit 907 comprising one or more memory units. The memory circuit 907 may be arranged to be used to store data such as, the information received by the processing circuit 906 in relation to signalling from the primary cell 221 and/or the neighbour cell 222, and applications to perform the methods herein when being executed in the wireless device 230. Memory circuit 907 may be in communication with the processing circuit 906. Any of the other information processed by the processing circuit 906 may also be stored in the memory circuit 907.

In some embodiments, signalling from the primary cell 221 and/or the neighbour cell 222 may be received through a receiving port 908. The receiving port 908 may be in communication with the processing circuit 906. The receiving port 908 may also be configured to receive other information.

The processing circuit 906 may be further configured to send signalling to the primary cell 221 and/or the neighbour cell 222 through a sending port 909, which may be in communication with the processing circuit 906, and the memory circuit 907.

Those skilled in the art will also appreciate that the measuring circuit 903, the adjusting circuit 904, the determining circuit 901, the sending circuit 902 and the receiving circuit 905 described above may refer to a combination of analog and digital circuits, and/or one or more processors configured with software and/or firmware (e.g., stored in memory) that, when executed by the one or more processors such as the processing circuit 906, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

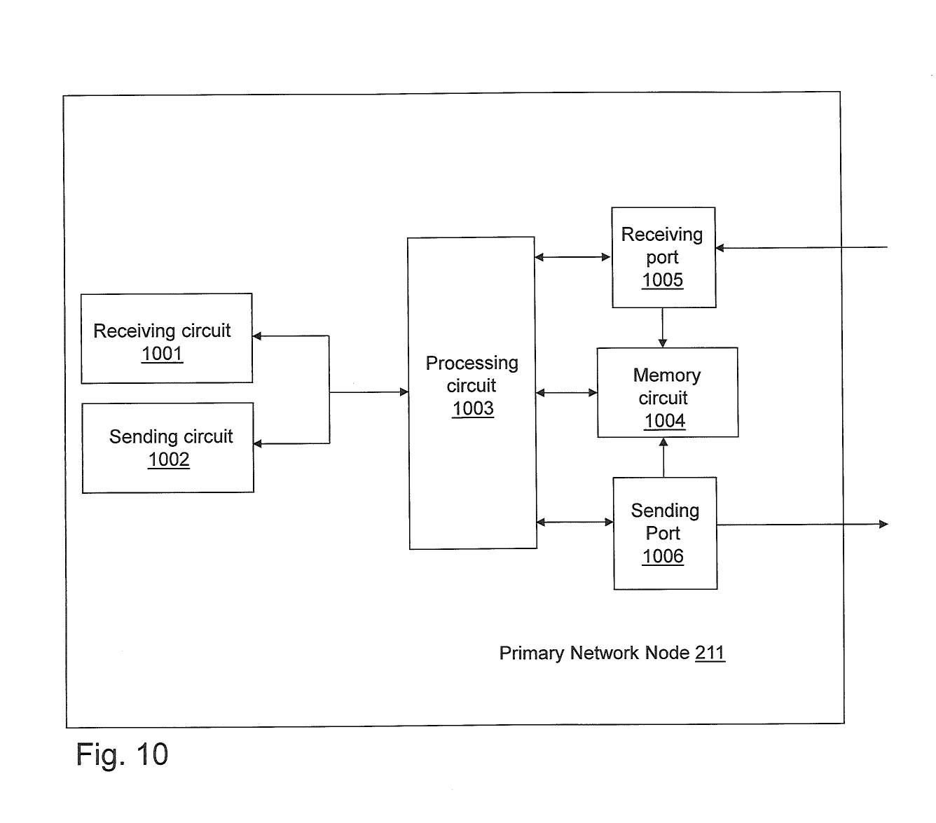

To perform the method actions in the primary network node 211 described above in relation to FIGS. 4-7 for handling a handover event from a primary cell 221 to a neighbour cell 222, the primary network node 211 comprises the following arrangement depicted in FIG. 10. As mentioned above, the primary cell 221 is serviced by a primary network node 211, the neighbour cell 222 is serviced by a neighbour network node 212, and the wireless device 230, the primary network node 211, the primary cell 221, the neighbour network node 212 and the neighbour cell 222 are comprised in a wireless communications network 200.

The primary network node 211 comprises a receiving circuit 1001, configured to receive a message from the wireless device 230 when an entering condition for a handover event is satisfied over a time period, as determined by the wireless device 230 when a first entering precondition and a second entering precondition are fulfilled, wherein the first entering precondition is based on a measurement of signal quality from the primary cell 221; and wherein the second entering precondition is based on a measurement of signal strength from the neighbour cell 222, and a measurement of signal strength from the primary cell 221, and wherein the message comprises a measurement report.

In some embodiments, the receiving circuit 1001 may also be configured to receive a message from the wireless device 230, when a leaving condition is satisfied over a time period or a second time period, wherein the message comprises a measurement report.

In some embodiments, the leaving condition for a handover event may be satisfied, as determined by the wireless device 230, by determining if a first leaving precondition or a second leaving precondition, are fulfilled, wherein the first leaving precondition is based on the measurement of signal quality from the primary cell 221; and wherein the second leaving precondition is based on the measurement of signal strength from the neighbour cell 222 and the measurement of signal strength from the primary cell 221.

In some embodiments, at least one of the second entering precondition and the second leaving precondition may be further based on at least one of: a frequency specific offset of a frequency of the primary cell 221, a frequency specific offset of a frequency of the neighbour cell 222, a cell specific offset of the neighbour cell 222, a hysteresis parameter, a cell specific offset of the primary cell 221 and an offset parameter; and the first entering precondition and the first leaving precondition may be further based on at least one of: a threshold parameter and the hysteresis parameter.

In some other embodiments, the first entering precondition may be:

Mpq+Hys<Thresh,

and the second entering precondition is:

Mn+Ofn+Ocn−Hys>Mp+Ofp+Ocp+Off,
wherein:
Mn is the measurement of signal strength from the neighbour cell 222,
Ofn is the frequency specific offset of the frequency of the neighbour cell 222,
Ocn is the cell specific offset of the neighbour cell 222, wherein Ocn is set to zero when configured for a cell that is not the neighbour cell 222,
Mp is the measurement of signal strength from the primary cell 221,
Mpq is the measurement of signal quality of the primary cell 221,
Ofp is the frequency specific offset of the primary frequency of the primary cell 221,
Ocp is the cell specific offset of the primary cell 221, and is set to zero when configured for a cell that is not the primary cell 221,
Hys is the hysteresis parameter for this event,
Off is the offset parameter, wherein the offset is an A7 offset parameter for this event,
Thresh is the threshold parameter for this event.

In some particular embodiments, the handover parameters just described may be further defined as described above in relation to an A7 handover event.

In some embodiments, the first leaving precondition may be:

Mpq−Hys<Thresh, and

and the second entering precondition is:

Mn+Ofn+Ocn+Hys<Mp+Ofp+Ocp+Off,

In some embodiments, the signal strength from the neighbour cell 222 and the signal strength from the primary cell 221 may be a Reference Signal Received Power, RSRP.

In some embodiments, the signal quality from the primary cell 221 may be a Reference Signal Received Quality, RSRQ, or a Signal to Interference and Noise Ratio, SINR.

In some embodiments, the cell specific offset of the neighbour cell 222 may have been adjusted by the wireless device 230 based on the measurement of signal quality of the primary cell 221.

In some embodiments, the primary network node 211 may further comprise a sending circuit 1002 configured to send a configuration message comprising configuration information to the wireless device 230.

The embodiments herein for handling a handover event from a primary cell 221 to a neighbour cell 222 may be implemented through one or more processors, such as a processing circuit 1003 in the primary network node 211, as depicted in FIG. 10, together with computer program code for performing the functions and actions of the embodiments herein, of similar characteristics to those described above for processing circuit 906.

The primary network node 211 may further comprise a memory circuit 1004, a receiving port 1005, and a sending port 1006, as depicted in FIG. 10, and of similar characteristics to those described above for memory circuit 907, a receiving port 908, and a sending port 909, respectively.

Those skilled in the art will also appreciate that the receiving circuit 1001 and the sending circuit 1002 described above may refer to a combination of analog and digital circuits, and/or one or more processors configured with software and/or firmware (e.g., stored in memory) that, when executed by the one or more processors such as the processing circuit 1003, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

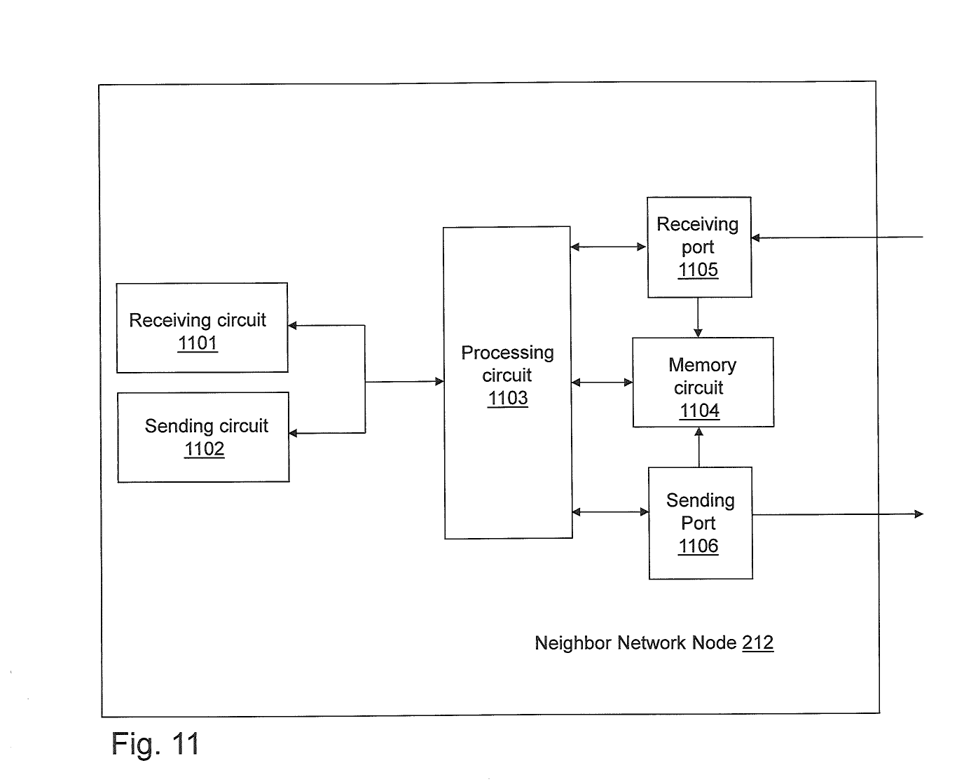

To perform the method actions in the neighbour network node 212 described above in relation to FIGS. 4-6 and 8 for handling a handover event from a primary cell 221 to a neighbour cell 222, the neighbour network node 212 comprises the following arrangement depicted in FIG. 11. As mentioned above, the primary cell 221 is serviced by a primary network node 211, the neighbour cell 222 is serviced by a neighbour network node 212, and the wireless device 230, the primary network node 211, the primary cell 221, the neighbour network node 212 and the neighbour cell 222 are comprised in a wireless communications network 200.

The neighbour network node 212 comprises a receiving circuit 1101, configured to receive a message from the wireless device 230 when an entering condition for a handover event is satisfied over a time period, as determined by the wireless device 230 when a first entering precondition and a second entering precondition are fulfilled, wherein the first entering precondition is based on a measurement of signal quality from the primary cell 221; and wherein the second entering precondition is based on a measurement of signal strength from the neighbour cell 222, and a measurement of signal strength from the primary cell 221, and wherein the message comprises a measurement report.

In some embodiments, the receiving circuit 1101 may also be configured to receive a message from the wireless device 230, when a leaving condition is satisfied over a time period or a second time period, wherein the message comprises a measurement report.

In some embodiments, the leaving condition for a handover event may be satisfied, as determined by the wireless device 230, by determining if a first leaving precondition or a second leaving precondition, are fulfilled, wherein the first leaving precondition is based on the measurement of signal quality from the primary cell 221; and wherein the second leaving precondition is based on the measurement of signal strength from the neighbour cell 222 and the measurement of signal strength from the primary cell 221.

In some embodiments, at least one of the second entering precondition and the second leaving precondition may be further based on at least one of: a frequency specific offset of a frequency of the primary cell 221, a frequency specific offset of a frequency of the neighbour cell 222, a cell specific offset of the neighbour cell 222, a hysteresis parameter, a cell specific offset of the primary cell 221 and an offset parameter; and the first entering precondition and the first leaving precondition may be further based on at least one of: a threshold parameter and the hysteresis parameter.

In some other embodiments, the first entering precondition may be:

Mpq+Hys<Thresh,

and the second entering precondition is:

Mn+Ofn+Ocn−Hys>Mp+Ofp+Ocp+Off,
wherein:
Mn is the measurement of signal strength from the neighbour cell 222,
Ofn is the frequency specific offset of the frequency of the neighbour cell 222,
Ocn is the cell specific offset of the neighbour cell 222, wherein Ocn is set to zero when configured for a cell that is not the neighbour cell 222,
Mp is the measurement of signal strength from the primary cell 221,
Mpq is the measurement of signal quality of the primary cell 221,
Ofp is the frequency specific offset of the primary frequency of the primary cell 221,
Ocp is the cell specific offset of the primary cell 221, and is set to zero when configured for a cell that is not the primary cell 221,
Hys is the hysteresis parameter for this event,
Off is the offset parameter, wherein the offset is an A7 offset parameter for this event,
Thresh is the threshold parameter for this event.

In some particular embodiments, the handover parameters just described may be further defined as described above in relation to an A7 handover event.

In some embodiments, the first leaving precondition may be:

Mpq−Hys>Thresh, and

the second leaving precondition is:

Mn+Ofn+Ocn+Hys<Mp+Ofp+Ocp+Off.

In some embodiments, the signal strength from the neighbour cell 222 and the signal strength from the primary cell 221 may be a Reference Signal Received Power, RSRP.

In some embodiments, the signal quality from the primary cell 221 may be a Reference Signal Received Quality, RSRQ, or a Signal to Interference and Noise Ratio, SINR.

In some embodiments, the cell specific offset of the neighbour cell 222 may have been adjusted by the wireless device 230 based on the measurement of signal quality of the primary cell 221.

In some embodiments, the neighbour network node 211 may further comprise a sending circuit 1102 configured to send a configuration message comprising configuration information to the wireless device 230.

The embodiments herein for handling a handover event from a primary cell 221 to a neighbour cell 222 may be implemented through one or more processors, such as a processing circuit 1103 in the neighbour network node 212 as depicted in FIG. 11, together with computer program code for performing the functions and actions of the embodiments herein, of similar characteristics to those described above for processing circuit 906.

The neighbour network node 2121 may further comprise a memory circuit 1104, a receiving port 1105, and a sending port 1106, as depicted in FIG. 11, and of similar characteristics to those described above for memory circuit 907, a receiving port 908, and a sending port 908, respectively.

Those skilled in the art will also appreciate that the receiving circuit 1101 and the sending circuit 1102 described above may refer to a combination of analog and digital circuits, and/or one or more processors configured with software and/or firmware (e.g., stored in memory) that, when executed by the one or more processors such as the processing circuit 1102, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appending claims.

1. A method in a wireless device for handling a handover event from a primary cell to a neighbour cell, the primary cell being serviced by a primary network node, the neighbour cell being serviced by a neighbour network node, and the wireless device, the primary network node, the primary cell, the neighbour network node and the neighbour cell being comprised in a wireless communications network, the method comprising:
determining if an entering condition for a handover event is satisfied by determining if a first entering precondition and a second entering precondition are fulfilled,
wherein the first entering precondition is based on a measurement of signal quality from the primary cell; and
wherein the second entering precondition is based on a measurement of signal strength from the neighbour cell, and a measurement of signal strength from the primary cell.

2. The method of claim 1, further comprising sending a message to one of: the primary network node and the neighbour network node, in response to the entering condition being satisfied over a time period, wherein the message comprises a measurement report for triggering the handover event.

3. The method of claim 1 further comprising:
determining if a leaving condition for the handover event is satisfied by determining if a first leaving precondition or a second leaving precondition, are fulfilled,
wherein the first leaving precondition is based on the measurement of signal quality from the primary cell; and
wherein the second leaving precondition is based on the measurement of signal strength from the neighbour cell and the measurement of signal strength from the primary cell.

4. The method of claim 3:
wherein at least one of the second entering precondition and the second leaving precondition is further based on at least one of: a frequency specific offset of a frequency of the primary cell, a frequency specific offset of a frequency of the neighbour cell, a cell specific offset of the neighbour cell, a hysteresis parameter, a cell specific offset of the primary cell, and an offset parameter; and
wherein the first entering precondition and the first leaving precondition are further based on at least one of: a threshold parameter and the hysteresis parameter.

5. The method of claim 4, wherein:
the first entering precondition is based on:
Mpq+Hys<Thresh, and
the second entering precondition is based on:
Mn+Ofn+Ocn−Hys>Mp+Ofp+Ocp+Off,
wherein:
Mn is the measurement of signal strength from the neighbour cell,
Ofn is the frequency specific offset of the frequency of the neighbour cell,
Ocn is the cell specific offset of the neighbour cell, wherein Ocn is set to zero when configured for a cell that is not the neighbour cell,
Mp is the measurement of signal strength from the primary cell,
Mpq is the measurement of signal quality of the primary cell,
Ofp is the frequency specific offset of the primary frequency of the primary cell,
Ocp is the cell specific offset of the primary cell, and is set to zero when configured for a cell that is not the primary cell,
Hys is the hysteresis parameter for this event,
Off is the offset parameter, wherein the offset is an A7 offset parameter for this event,
Thresh is the threshold parameter for this event.

6. The method of claim 5, wherein
the first leaving precondition is based on:
Mpq−Hys>Thresh, and
the second leaving precondition is based on:
Mn+Ofn+Ocn+Hys<Mp+Ofp+Ocp+Off.

7. The method of claim 1, wherein the signal strength from the neighbour cell and the signal strength from the primary cell is a Reference Signal Received Power (RSRP).

8. The method of claim 1, wherein the signal quality from the primary cell is a Reference Signal Received Quality (RSRQ) or a Signal to Interference and Noise Ratio (SINR).

9. The method of claim 1, wherein the primary network node is the same as the neighbour network node.

10. The method of claim 4, further comprising adjusting the cell specific offset of the neighbour cell based on the measurement of signal quality of the primary cell.

11. A method in a primary network node for handling a handover event of a wireless device from a primary cell to a neighbour cell, the primary cell being serviced by the primary network node, the neighbour cell being serviced by a neighbour network node, and the wireless device, the primary network node, the primary cell, the neighbour network node and the neighbour cell being comprised in a wireless communications network, the method comprising:
receiving a message from the wireless device in response to an entering condition for a handover event being satisfied over a time period, as determined by the wireless device when a first entering precondition and a second entering precondition are fulfilled,
wherein the first entering precondition is based on a measurement of signal quality from the primary cell; and
wherein the second entering precondition is based on a measurement of signal strength from the neighbour cell and a measurement of signal strength from the primary cell,
wherein the message comprises a measurement report.

12. A method in a neighbour network node for handling a handover event of a wireless device from a primary cell to a neighbour cell, the primary cell being serviced by a primary network node, the neighbour cell being serviced by the neighbour network node, and the wireless device, the primary network node, the primary cell, the neighbour network node and the neighbour cell being comprised in a wireless communications network, the method comprising:
receiving a message from the wireless device in response to an entering condition for a handover event being satisfied over a time period, as determined by the wireless device when a first entering precondition and a second entering precondition are fulfilled,
wherein the first entering precondition is based on a measurement of signal quality from the primary cell; and
wherein the second entering precondition is based on a measurement of signal strength from the neighbour cell, and a measurement of signal strength from the primary cell,
wherein the message comprises a measurement report.

13. A wireless device for handling a handover event from a primary cell to a neighbour cell, the primary cell being serviced by a primary network node, the neighbour cell being serviced by a neighbour network node, and the wireless device, the primary network node, the primary cell, the neighbour network node and the neighbour cell being comprised in a wireless communications network, the wireless device comprising:
a determining circuit configured to determine if an entering condition for a handover event is satisfied by determining if a first entering precondition and a second entering precondition are fulfilled,
wherein the first entering precondition is based on a measurement of signal quality from the primary cell; and
wherein the second entering precondition is based on a measurement of signal strength from the neighbour cell, and a measurement of signal strength from the primary cell.

14. The wireless device of claim 13, further comprising a sending circuit configured to send a message to one of: the primary network node and the neighbour network node, in response to the entering condition being satisfied over a time period, wherein the message comprises a measurement report.

15. The wireless device of claim 13 wherein the determining circuit is further configured to determine if a leaving condition for a handover event is satisfied by determining if a first leaving precondition or a second leaving precondition, are fulfilled,
wherein the first leaving precondition is based on the measurement of signal quality from the primary cell; and
wherein the second leaving precondition is based on the measurement of signal strength from the neighbour cell and the measurement of signal strength from the primary cell.

16. The wireless device of claim 14:
wherein at least one of the second entering precondition and the second leaving precondition is further based on at least one of: a frequency specific offset of a frequency of the primary cell, a frequency specific offset of a frequency of the neighbour cell, a cell specific offset of the neighbour cell, a hysteresis parameter, a cell specific offset of the primary cell, and an offset parameter; and
wherein the first entering precondition and the first leaving precondition are further based on at least one of: a threshold parameter and the hysteresis parameter.

17. The wireless device of claim 13, wherein:
the first entering precondition is based on:
Mpq+Hys<Thresh,
the second entering precondition is based on:
Mn+Ofn+Ocn−Hys>Mp+Ofp+Ocp+Off,
wherein:
Mn is the measurement of signal strength from the neighbour cell,
Ofn is the frequency specific offset of the frequency of the neighbour cell,
Ocn is the cell specific offset of the neighbour cell, wherein Ocn is set to zero when configured for a cell that is not the neighbour cell,
Mp is the measurement of signal strength from the primary cell,
Mpq is the measurement of signal quality of the primary cell,
Ofp is the frequency specific offset of the primary frequency of the primary cell,
Ocp is the cell specific offset of the primary cell, and is set to zero when configured for a cell that is not the primary cell,
Hys is the hysteresis parameter for this event,
Off is the offset parameter, wherein the offset is an A7 offset parameter for this event,
Thresh is the threshold parameter for this event.

18. The wireless device of claim 17, wherein:
the first leaving precondition is based on:
Mpq−Hys>Thresh, and
the second leaving precondition is based on:
Mn+Ofn+Ocn+Hys<Mp+Ofp+Ocp+Off.

19. The wireless device of claim 13, wherein the signal strength from the neighbour cell and the signal strength from the primary cell is a Reference Signal Received Power, RSRP.

20. The wireless device of claim 13, wherein the signal quality from the primary cell is a Reference Signal Received Quality, RSRQ, or a Signal to Interference and Noise Ratio, SINR.

21. The wireless device of claim 13, further comprising an adjusting circuit configured to adjust the cell specific offset of the neighbour cell based on the measurement of signal quality of the primary cell.

22. A primary network node for handling a handover event of a wireless device from a primary cell to a neighbour cell, the primary cell being serviced by the primary network node, the neighbour cell being serviced by a neighbour network node, and the wireless device, the primary network node, the primary cell, the neighbour network node and the neighbour cell being comprised in a wireless communications network, the primary network node comprising:
a receiving circuit configured to receive a message from the wireless device when an entering condition for a handover event is satisfied over a time period, as determined by the wireless device in response to a first entering precondition and a second entering precondition being fulfilled,
wherein the first entering precondition is based on a measurement of signal quality from the primary cell; and
wherein the second entering precondition is based on a measurement of signal strength from the neighbour cell, and a measurement of signal strength from the primary cell,
wherein the message comprises a measurement report.

23. A neighbour network node for handling a handover event of a wireless device from a primary cell to a neighbour cell, the primary cell being serviced by a primary network node, the neighbour cell being serviced by the neighbour network node, and the wireless device, the primary network node, the primary cell, the neighbour network node and the neighbour cell being comprised in a wireless communications network, the neighbour network node comprising:
a receiving circuit configured to receive a message from the wireless device in response to an entering condition for a handover event being satisfied over a time period, as determined by the wireless device when a first entering precondition and a second entering precondition are fulfilled,
wherein the first entering precondition is based on a measurement of signal quality from the primary cell; and
wherein the second entering precondition is based on a measurement of signal strength from the neighbour cell, and a measurement of signal strength from the primary cell,
wherein the message comprises a measurement report.
